(19) United States
(12) Patent Application Publication
(10) Pub. No.: US 2025/0154342 A1
(43) Pub. Date: May 15, 2025

(54) CHEMICALLY END-CAPPED MELAMINE PYROPHOSPHATE WITH HIGH TEMPERATURE RESISTANCE AND PRECIPITATION RESISTANCE, PREPARATION METHOD AND APPARATUS THEREOF, AND APPLICATION THEREOF IN FLAME-RETARDANT NYLON

(71) Applicants: Chongqing Copolyforce New Materials Co.,Ltd., Chongqing (CN); CCTEG CHONGQING RESEARCH INSTITUTE, Chongqing (CN)

(72) Inventors: Zhi HU, Chongqing (CN); Zhiqiang ZHONG, Chongqing (CN); Tao SHI, Chongqing (CN); Xiaodi GONG, Chongqing (CN); Xueliang DING, Chongqing (CN); Yuchen WANG, Chongqing (CN); Qing MEI, Chongqing (CN); Xu XU, Chongqing (CN); Lei ZHOU, Chongqing (CN); Jian CHEN, Chongqing (CN); Qiang LV, Chongqing (CN); Fushun LI, Chongqing (CN); Xin ZHOU, Chongqing (CN); Quanguo HE, Chongqing (CN); Shuying YE, Chongqing (CN); Xiaolin LIU, Chongqing (CN); Gang LIU, Chongqing (CN)

(73) Assignees: Chongqing Copolyforce New Materials Co.,Ltd., Chongqing (CN); CCTEG CHONGQING RESEARCH INSTITUTE, Chongqing (CN)

(21) Appl. No.: 19/020,931

(22) Filed: Jan. 14, 2025

Related U.S. Application Data
(63) Continuation-in-part of application No. PCT/CN2024/105797, filed on Jul. 16, 2024.

(30) Foreign Application Priority Data
May 17, 2023 (CN) 202310559978.0

(51) Int. Cl. C08K 5/52

(52) U.S. Cl. CPC C08K 5/5205

(57) ABSTRACT

Disclosed are chemically end-capped melamine pyrophosphate with high temperature resistance and precipitation resistance, a preparation method and apparatus thereof, and an application thereof in flame-retardant nylon. End-capping treatment of melamine pyrophosphate enhances flame retardancy and precipitation resistance of a flame retardant, and melamine pyrophosphate is used for producing high-strength flame-retardant nylon, which improves product performance. A special flame-retardant preparation device is also used, and appropriate process flow and parameter design further improves comprehensive properties of the flame retardant, including whiteness and a 1% thermal decomposition temperature. The present technical solution can overcome technical defects of the melamine pyrophosphate flame retardant in the prior art including non-ideal properties in a flame retardant effect and stability, as well as difficulty to improve the comprehensive properties of the flame-retardant nylon. The process is simple but ideal in the effect, and is suitable for a wide range of applications.

### CROSS-REFERENCE TO RELATED APPLICATIONS

The application claims priority to Chinese patent application No. 202310559978.0, filed on May 17, 2023, the entire contents of which are incorporated herein by reference.

### TECHNICAL FIELD

The present disclosure relates to the technical field of flame retardants, and specifically relates to chemically end-capped melamine pyrophosphate with high temperature resistance and precipitation resistance, a preparation method and apparatus thereof, and an application thereof in flame-retardant nylon.

### BACKGROUND

Melamine and its phosphate salts are widely used in polymers or coatings such as plastic and rubber, and have excellent flame-retardant and fire-resistant properties. Melamine not only has functions of general intumescent flame retardants, but also has its own advantages: (1) low water solubility of usually less than 0.5 g at room temperature, which is of great benefit to a coating system under humid conditions and to compatibility of plastic and rubber; (2) high thermal stability, which is not only beneficial to processing and molding of flame-retardant plastic and rubber, but also improves flame-retardant and fire-resistant properties; (3) excellent flame retardancy: due to an ideal synergistic effect of phosphorus and nitrogen, phosphorus and nitrogen are easily dissolved to generate (PON)ₓ, and a series of condensation and polymerization products are gradually generated during thermal degradation, accompanied by generation of water vapor that absorbs a lot of heat, non-flammable ammonia and other gases, which exerts a good effect of coordinating expansion and charring of an entire intumescent system and increases intumescent char layers formed; (4) good compatibility with other flame-retardants, e.g., melamine pyrophosphate and ammonium polyphosphate can be mixed at a certain ratio to achieve a better flame-retardant effect.

Melamine pyrophosphate is synthesized by means of the following two methods: preparing through a reaction between polyphosphoric acid and melamine under acidic conditions; and preparing by direct dehydration of melamine phosphate at a certain temperature through a solid-phase synthesis method. However, when the first method is used, the problem concerning the synthesis of melamine phosphate also exists: there are excessive inorganic salts in the product; and the second method has the following defect: a solid-phase reaction results in difficult mass transfer and heat transfer, and somewhat difficult production. For example, Chinese patents CN 102127230 A, CN IO5504292 A and CN 104693483 A primarily involve calcining melamine orthophosphate at temperatures ranging from 120° C. to 350° C. Various types of devices can be used for calcination, such as a hot air drying device, a kneader, a rotary kiln, a paddle dryer, and an extruder. In recent years, many new varieties of improved melamine pyrophosphate have emerged, such as Hostaflam AP-750, Melapur PA-90 and MELAPUR P46. Relatively mature products that have been industrially produced include Melapur 200-70 from BASF of Germany, which can achieve a 1% thermal weight loss of greater than or equal to 350° C.; XPM-1000 developed and sold by MONSANTO of the United States; Melabis designed and synthesized by Borg-Warner Chemicals of the United States; and an intumescent flame retardant Char-Guard CN-329 produced by Great Lakes Chemicals of the United States, as shown in Formula (1).

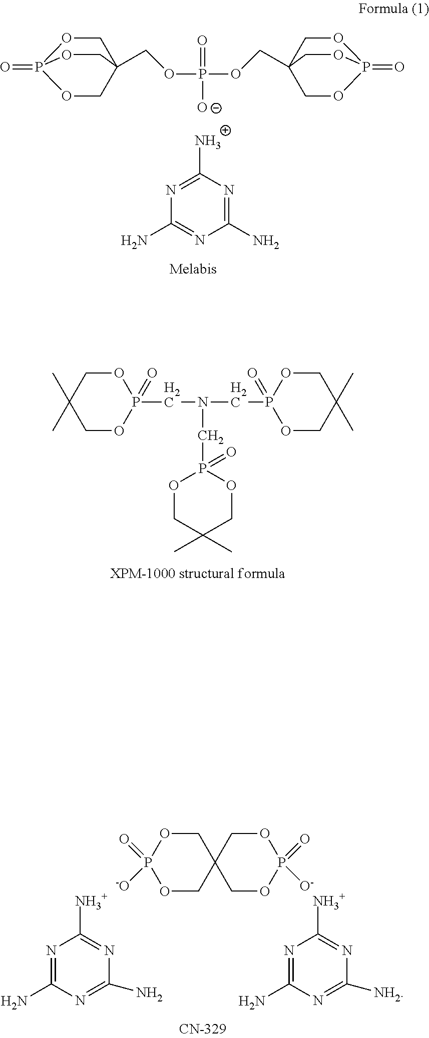

Currently, research and development of melamine pyrophosphate focus on the improvement of preparation processes, optimization of synthesis routes, and development of composite synergistic technologies. Although melamine pyrophosphate has certain water resistance, its temperature resistance and precipitation resistance still cannot meet all product requirements, and it is urgent to develop a new type of melamine pyrophosphate and a preparation method therefor to meet practical application needs.

### SUMMARY

An objective of the present disclosure is to provide a chemically end-capped melamine pyrophosphate flame retardant with high temperature resistance and precipitation resistance, so as to overcome technical defects of the melamine pyrophosphate flame retardant in the prior art including non-ideal properties in a flame retardant effect and stability.

To achieve the above objective, the present disclosure adopts the following technical solution:
a chemically end-capped melamine pyrophosphate flame retardant with high temperature resistance and precipitation resistance, where a structure of the melamine pyrophosphate is represented by a following chemical formula, and the melamine pyrophosphate is end-capped by an end-capping reagent;

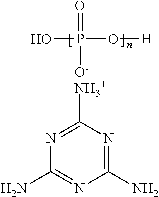

where n=1000-3000; and the end-capping reagent is a nitrogen-containing compound containing no hydroxyl group but an N—H bond.

In this solution, there is further provided a method for preparing a chemically end-capped melamine pyrophosphate flame retardant with high temperature resistance and precipitation resistance, and the method includes the following steps performed sequentially:
S1: dehydrating melamine phosphate by thermal polymerization to obtain melamine pyrophosphate;
S2: performing thermal treatment of the melamine pyrophosphate and the end-capping reagent, to obtain the chemically end-capped melamine pyrophosphate.

In this solution, there is further provided an application of the chemically end-capped melamine pyrophosphate flame retardant with high temperature resistance and precipitation resistance in flame-retardant nylon.

Further, the end-capping reagent includes at least one of R—NH₂, R═NH, melamine, urea, biguanide and iminodiacetonitrile; and R is an alkyl group with 1-4 carbon atoms.

Further, reaction processes of S1 and S2 are both executed in an inert gas environment; a reaction temperature, pressure and time of S1 are 220-360° C., 0.05-0.3 MPa, and 60-300 min, respectively; and a reaction temperature, pressure and time of S2 are 180-360° C., 0.1-1.5 MPa, and 30-240 min, respectively.

Further, the reaction processes of S1 and S2 are both executed in a thermal polymerization reaction device; the thermal polymerization reaction device comprises a rotary furnace and a temperature control unit; a reaction chamber is arranged in the rotary furnace, and a material stirring screw is coaxially arranged in the reaction chamber; the temperature control unit is configured for controlling a temperature in the reaction chamber; and during the reaction process, the material stirring screw and the reaction chamber maintain different rotation directions.

Further, a rotation speed of the material stirring screw is 30-300 rpm, and a rotation speed of the reaction chamber is 3-120 rpm.

Further, the flame-retardant nylon includes the following raw materials in parts by weight: 30-80 parts of nylon, 5-60 parts of long glass fiber, 5-20 parts of chemically end-capped melamine pyrophosphate, 5-20 parts of organic aluminum hypophosphite, 0.5-4 parts of a flame-retardant synergist, 0.3-2 parts of a nucleating agent, 0.5-2 parts of a coupling agent, 0.3-3 parts of a lubricant, and 0.2-1 part of an antioxidant.

Further, the nylon includes at least one of nylon 6, nylon 66, nylon 46, nylon 610, nylon 612, nylon 9, nylon 11, nylon 12, nylon 1010, nylon 1012, and nylon 1212; the long glass fiber is a rolled alkali-free glass fiber; the organic aluminum hypophosphite is aluminum diethylphosphinate; the flame-retardant synergist includes at least one of anhydrous zinc borate, zinc borate 3.5 hydrate, zinc oxide, and zirconium phosphate; the nucleating agent is BRUGGOLEN P22; the coupling agent is a silane coupling agent; the lubricant includes at least one of ethylene bis stearamide, pentaerythritol stearate, silicone powder and amide wax; and the antioxidant includes at least one of an antioxidant 168, an antioxidant 1010 and an antioxidant 1098.

The flame-retardant nylon is prepared by the following method:
S1: adding nylon, chemically end-capped melamine pyrophosphate, organic aluminum hypophosphite and a flame-retardant synergist into a mixer, and stirring at room temperature for 5-30 min;
S2: increasing a temperature of the mixer to 80-180° C., and adding a coupling agent and continuing to stir for 10-30 min;
S3: after cooling to room temperature, adding a lubricant, a nucleating agent and an antioxidant, and stirring for 5-30 min to obtain a premix; and
S4: extruding the premix through a twin-screw extruder at a temperature of 200-300° C., wherein the long glass fiber is fed through a glass fiber opening, and then performing screening and dehydration through processes of drawing and pelletizing, to obtain flame-retardant reinforced nylon granules.

The beneficial effects of this technical solution are as follows:

Compared with the prior art, the present disclosure shows a good polymerization effect on melamine pyrophosphate, achieves uniform heating, uniform and complete polymerization, and no sticking to a reaction kettle, and solves the problem of unstable thermal decomposition of solid-phase synthesis products; and after the chemical end-capping, water resistance, temperature resistance and flame retardancy are improved.
(1) The present disclosure improves the temperature resistance of melamine pyrophosphate, improves the precipitation resistance through the chemical end-capping, and increases nitrogen content to be greater than 42%; and
(2) a production device for synthesizing melamine pyrophosphate through the chemical end-capping and thermal polymerization is designed and can be used for continuous scale-up production, which ensures product whiteness (the whiteness of greater than 98%) and thermal stability (a 1% thermal weight loss of greater than 370° C.); and
(3) the application of melamine pyrophosphate (chemically end-capped) in flame-retardant nylon: by compounding according to a flame-retardant formula and adding about 10%, the flame-retardant effect reaches 0.8 mmV-0, and the product passes a UL 746C immersion test and a GB/T 2423.50 “double 85” test for 1000 h without precipitation.

### BRIEF DESCRIPTION OF DRAWINGS

FIG. 1 is a front view of a polymerization reaction device for continuous production according to Example 1.

FIG. 2 is a sectional view of FIG. 1 in an A-A direction.

FIG. 3 is a front view (a sectional view) of a material stirring screw according to Example 1.

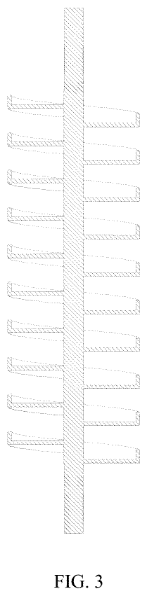

FIG. 4 is a TG chart of commercially available melamine pyrophosphate according to Experimental Example 1.

### DETAILED DESCRIPTION OF THE EMBODIMENTS

The present disclosure will be described in further details in conjunction with examples below, but the embodiments of the present disclosure are not limited thereto. Unless otherwise specified, technical means used in the following examples and experimental examples are conventional means well known to those skilled in the art, and materials, reagents and the like can all be obtained commercially.

Reference numerals in the figures: cylinder 1, hot oil tank 2, cold oil tank 3, driven gear 4, driving gear 5, oil chamber 6, stirring screw 7, first motor 8, feed inlet 9, nitrogen outlet 10, discharge outlet 11, nitrogen inlet 12, load-bearing wheel 13, second motor 14, support column 15, first conduit 16, first oil pump 17, second conduit 18, second oil pump 19, first rotary joint 20, first rotary conduit 21, second rotary joint 22, second rotary conduit 23, third conduit 24, frame 25, and insulation layer 26.

### Example 1: Chemically End-Capped Melamine Pyrophosphate

### (1) Synthesis Process

A synthesis process of the chemically end-capped melamine pyrophosphate is roughly as follows:

With deionized water as a solvent, melamine (ME) reacts with H₃PO₄ through acid-base neutralization to prepare melamine phosphate (MP) with high purity, high whiteness and high thermal stability, and then the MP is then subjected to high-temperature thermal polymerization to obtain melamine pyrophosphate (MPP). The above synthesis process can be found in the paper previously published by the inventor: “Zhong Zhiqiang, Synthesis of melamine pyrophosphate and properties of flame-retardant polypropylene, Engineering Plastics Application, 2018”. Specifically, in this example, a method for preparing melamine phosphate is as follows: a molar ratio of ME to H₃PO₄ is 1:1.05, reaction time is 2.0 h, a reaction temperature is 95° C., and a molar ratio of ME to deionized water is 3:97. Melamine phosphate (Formula (2)) is synthesized under the above conditions. Then, melamine phosphate is used to synthesize melamine pyrophosphate, and the synthesis reaction occurs in a dedicated polymerization reaction device for continuous production in this solution. Melamine phosphate is subjected to thermal treatment at 220-360° C. for 60-300 min, and in an inert gas environment (such as nitrogen), thermal polymerization is performed at a pressure of 0.05-0.3 MPa for dehydration and condensation into melamine pyrophosphate (Formula (2)) of a certain molecular weight, with a reaction formula as referenced in Formula (4). Then, an end-capping reagent (a mass ratio of the end-capping reagent to the melamine pyrophosphate is 3-100:10000) is added to a reaction system (the dedicated polymerization reaction device for continuous production in this solution is also used). The thermal treatment is continued at a temperature of 180-360° C. and a pressure of 0.1-1.5 MPa for 30-240 min in the inert gas environment (such as nitrogen), and grinding is performed after cooling to obtain the chemically end-capped melamine pyrophosphate (Formula (5), taking R—NH₂ and R═NH as the end-capping reagent as an example), with the reaction process shown in Formula (6). In the above two-step reaction process, a material stirring screw and a cylinder of a rotary furnace rotate in different directions, and for example, when the material stirring screw rotates counterclockwise at a speed of 30-300 rpm, the cylinder of the rotary furnace rotates clockwise at a speed of 3-120 rpm (preferably 3-60 rpm).

The end-capping reagent is a nitrogen-containing compound containing no hydroxyl group but an N—H bond, which can be R—NH₂ or R═NH, where R is an alkyl group with 1-4 carbon atoms; or melamine and its compounds without hydroxyl group composed of R—NH₂ and R═NH; or an amino compound without hydroxyl group composed of R—NH₂ and R═NH (such as urea); or an imino compound without hydroxyl group composed of R—NH₂ and R═NH (such as a compound containing a guanidine group (NH₂)₂—C═NH, biguanide (1-(diaminomethylene) guanidine), iminodiacetonitrile C₄H₅N₃). Further, in Formula (3), Formula (4), Formula (5) and Formula (6), n=1000-3000.

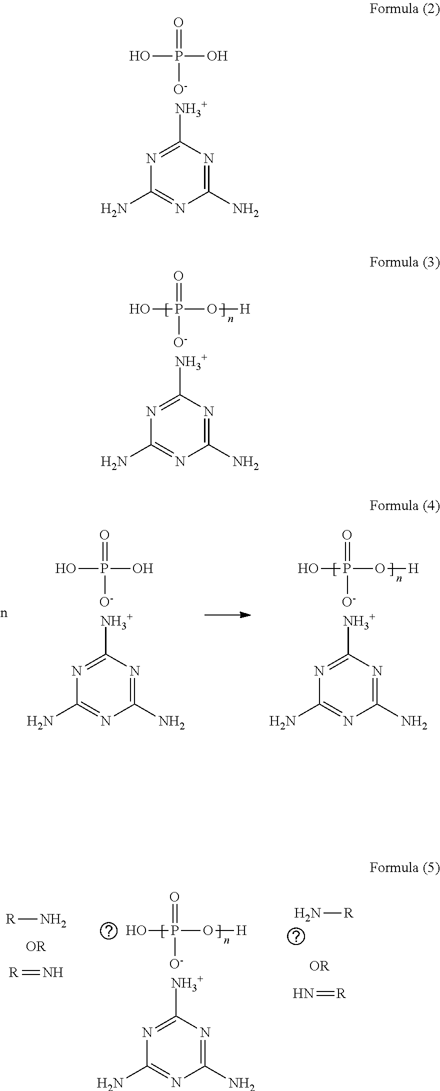

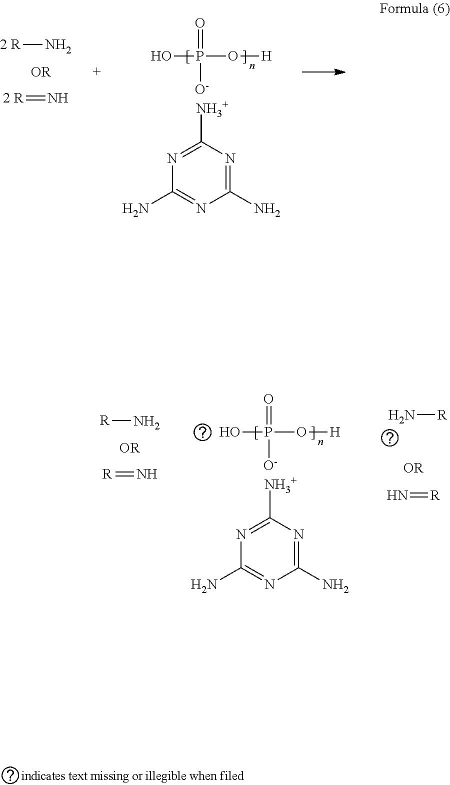

### (2) Synthesis Device

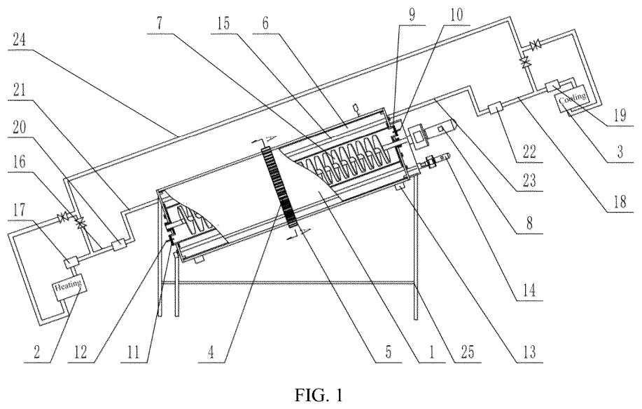

A special device used in this technical solution is shown in FIG. 1. A polymerization reaction device for continuous production includes a rotary furnace and a temperature control unit, where the rotary furnace includes an inclined cylinder 1, and the temperature control unit includes a hot oil tank 2 and a cold oil tank 3.

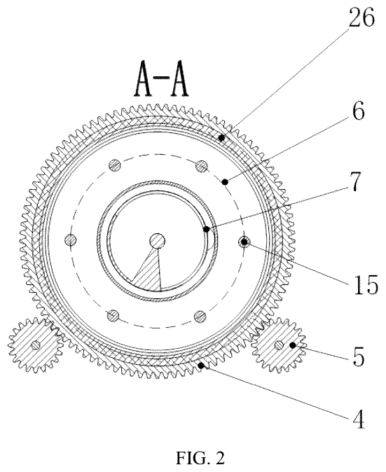

With reference to FIGS. 1 and 2, a driven gear 4 is sleeved and fixed on an outer side of the cylinder 1, the cylinder 1 and the driven gear 4 are concentrically arranged, two driving gears 5 (left and right) are meshed with the driven gear 4, and the driving gears 5 drive the cylinder 1 to rotate. The cylinder 1 has a double-layer structure, including an inner wall and an outer wall that are cylindrical and coaxially arranged, an oil chamber 6 is formed between the inner wall and the outer wall, and an outer side of the outer wall is covered with an insulation layer 26. A cavity formed by enclosing the inner wall is a reaction chamber, and a material stirring screw 7 is arranged in the reaction chamber. An upper end and a lower end of the material stirring screw 7 are rotatably connected to a top and a bottom of the cylinder 1. The upper end of the material stirring screw 7 is fixedly connected to an output shaft of a first motor 8, and the first motor 8 is fixed on the frame 25. A feed inlet 9 and a nitrogen outlet 10 are arranged at the top of the cylinder 1, and a discharge outlet 11 and a nitrogen inlet 12 are arranged at the bottom of the cylinder 1. An outer wall of the cylinder 1 is in contact with two sets of load-bearing wheels 13 from top to bottom (either set includes two load-bearing wheels 13), and the load-bearing wheels 13 are fixed in position and rotatably connected to the frame 25, which play a role of supporting the cylinder 1 and cooperate with rotation of the cylinder 1. The driving gears 5 are rotatably connected to the frame 25, a second motor 14 is fixed to the frame 25, and the driving gears 5 are driven by the second motor 14 through a conventional transmission structure in the prior art. The driving gears 5 drive the cylinder 1 to rotate through the driven gear 4. A plurality of support columns 15 parallel to a central axis of the cylinder 1 are arranged in the oil chamber 6, and upper and lower ends of the support columns 15 are fixed to the top and the bottom of the cylinder 1.

The hot oil tank 2 is communicated with a first conduit 16, and a first oil pump 17 is arranged on the first conduit 16; and the cold oil tank 3 is communicated with a second conduit 18, and a second oil pump 19 is arranged on the second conduit 18. The first conduit 16 is communicated with a first rotary conduit 21 through a first rotary joint 20; and the second conduit 18 is communicated with a second rotary conduit 23 through a second rotary joint 22. One end of the first rotary conduit 21 is communicated with the oil chamber 6 and is fixed to the bottom of the cylinder 1; and one end of the second rotary conduit 23 is communicated with the oil chamber 6 and is fixed to the top of the cylinder 1.

The temperature control unit further includes a third conduit 24. A lower end of the third conduit 24 is communicated with two branches (a branch A and a branch B), the branch B is communicated with the first conduit 16, and the branch A is communicated with the hot oil tank 2; and the branch A and the branch B are both provided with corresponding control valves. An upper end of the third conduit 24 is communicated with two branches (a branch C and a branch D), the branch D is communicated with the second conduit 18, and the branch C is communicated with the cold oil tank 3; and the branch C and the branch D are both provided with corresponding control valves. When hot oil circulates, the branch B is closed, the branch C is closed, the second oil pump 19 is stopped, the first oil pump 17 is started, the branch A is opened, and the branch D is opened. In this way, a closed loop is formed between the hot oil tank 2, the first conduit 16, the first rotary conduit 21, the oil chamber 6, the second rotary conduit 23, the second conduit 18 and the third conduit 24. Under the action of the first oil pump 17, the hot oil circulates therein to ensure a temperature in the reaction chamber. After a heating reaction is completed, the branch A is closed, and the hot oil in a pipeline returns to the hot oil tank 2 under the action of the first oil pump 17 and a gravity of the hot oil itself. After the reaction is completed, cold oil in the cold oil tank 3 is used to cool a reacted material.

When the cold oil circulates, the branch A is closed, the branch D is closed, the first oil pump 17 is stopped, the branch B is opened, the branch C is opened, and the second oil pump 19 is started. In this way, a closed loop is formed between the cold oil tank 3, the second conduit 18, the second rotary conduit 23, the oil chamber 6, the first rotary conduit 21, the first conduit 16 and the third conduit 24. Under the action of the second oil pump 18, the cold oil circulates therein to cool down the reaction chamber. After the cooling is completed, the branch C is closed, and under the action of the second oil pump 18, the cold oil in the pipeline is pumped back to the cold oil tank 3. According to the above process, hot oil circulation and cold oil circulation can be performed alternately according to actual needs to achieve continuous production.

A specific process of using this device is as follows:

A. At the beginning of a thermal polymerization reaction, the hot oil tank 2 starts to work, the oil is heated to a processing temperature, a material and an inert protective gas are added to the reaction chamber, and the first oil pump 17 is started to press the hot oil in the hot oil tank 2 into the oil chamber 6 on the outer wall of the cylinder 1 of the rotary furnace for the thermal polymerization reaction, such that the oil circulates between the hot oil tank 2 and the oil chamber 6 on the outer wall of the cylinder 1, and is quickly heated to a specified temperature and maintains a constant temperature.

B. During the reaction process, a circulation is formed between the hot oil tank 2 and the oil chamber 6 on the outer wall of the cylinder 1 to keep the temperature constant during reaction time, and a reaction pressure is adjusted by extracting or adding the inert gas. During the entire thermal polymerization process, a rotation direction of the material stirring screw 7 remains opposite to that of the reaction chamber.

C. After the reaction is completed, the first oil pump 17 is started to pump the hot oil in the rotary furnace for the thermal polymerization reaction into the hot oil tank 2, and then the second oil pump 19 is started to press the cold oil in the cold oil tank 3 into the oil chamber 6 on the outer wall of the cylinder 1 for the thermal polymerization reaction, such that the oil circulates between the cold oil tank 3 and the oil chamber 6 on the outer wall of the rotary furnace to achieve rapid cooling.

D. After the temperature in a feeding pipe drops to a specified temperature and the material is discharged, the second oil pump 19 is started to press the oil in the oil chamber 6 on the outer wall of the rotary furnace into the cold oil tank 3, then the material and the inert protective gas are added, after air in the feeding pipe is discharged, the hot oil in the hot oil tank 2 is pressed into the oil chamber 6 on the outer wall of the cylinder 1 of the rotary furnace, and the steps A-D are repeated to achieve the continuous production.

In the synthesis process of the present technical solution, the material (melamine phosphate) and the inert protective gas (nitrogen, 0.05-0.3 MPa) are added to the reaction chamber, and the reaction chamber is heated to 220-360° C. and kept at a constant temperature by the hot oil circulation, and the reaction lasts for 60-300 min to complete the first step of the reaction. Then, the reaction pressure is adjusted to 0.1-1.5 MPa by introducing nitrogen, the hot oil temperature is adjusted to a reaction temperature of 180-360° C., and the material (the end-capping reagent) in the reaction chamber reacts for 30-240 min to obtain the chemically end-capped melamine pyrophosphate. After the reaction is completed, the material is directly discharged to a storage bin outside the system for cooling. This solution mainly serves for the synthesis of target substances, and utilizes functions of the above device including constant temperature heating, maintaining of the reaction pressure through the inert protective gas, and maintaining of the material stirring screw 7 and the reaction chamber in different directions of rotation, rather than functions of cold oil cooling and continuous production. In the use process, the material is added to the reaction chamber, the reaction chamber is filled with nitrogen to adjust to an appropriate pressure, the hot oil circulation is started to control the temperature of the reaction chamber, and the material stirring screw 7 and the reaction chamber rotate in different directions during the reaction process. The pressure of nitrogen in the reaction chamber and the temperature of the hot oil tank 2 are adjusted according to needs of different stages of the reaction. After the reaction is completed, the cold oil cooling is not performed, and the material is directly taken out and placed in the storage bin for cooling.

### Example 2: An Application of Chemically End-Capped Melamine Pyrophosphate in Flame-Retardant Nylon

A flame-retardant reinforced nylon composition includes the following raw materials in parts by weight: 30-80 parts of nylon, 5-60 parts of long glass fiber, 5-20 parts of chemically end-capped melamine pyrophosphate (or domestic common melamine pyrophosphate), 5-20 parts of organic aluminum hypophosphite, 0.5-4 parts of a flame-retardant synergist, 0.3-2 parts of a nucleating agent, 0.5-2 parts of a coupling agent, 0.3-3 parts of a lubricant, and 0.2-1 part of an antioxidant. The reinforced nylon composition not only has good flame retardancy, but also demonstrates very excellent mechanical properties, temperature resistance and precipitation resistance.

The nylon is any one or a mixture of more of nylon 6, nylon 66, nylon 46, nylon 610, nylon 612, nylon 9, nylon 11, nylon 12, nylon 1010, nylon 1012, and nylon 1212. The long glass fiber is a rolled alkali-free glass fiber, with a diameter of 6-10 μm. The organic aluminum hypophosphite is aluminum diethylphosphinate. The flame-retardant synergist is any one or a mixture of more of anhydrous zinc borate, zinc borate 3.5 hydrate, zinc oxide, and zirconium phosphate. The nucleating agent is BRUGGOLEN P22. The coupling agent is a silane coupling agent, and can be any one or a mixture of more of an amino silane coupling agent KH-9120, an isocyanate silane coupling agent KT-930, and epoxy silane coupling agents KH-1006 and KH-9130. The lubricant is one or more of ethylene bis stearamide, pentaerythritol stearate, silicone powder and amide wax. The antioxidant is an antioxidant 168, an antioxidant 1010, or an antioxidant 1098.

The flame-retardant nylon is prepared by the following method:
S1: add nylon, chemically end-capped melamine pyrophosphate (or the domestic common melamine pyrophosphate), organic aluminum hypophosphite and a flame-retardant synergist into a mixer, and stir at room temperature for 5-30 min;
S2: in a mixture of the S1, increase a temperature of the mixer to 80-180° C., ensure that the temperature of material in the mixer reaches a set temperature, and then add a coupling agent and continue stirring for 10-30 min;
S3: after cooling the mixture in the S2 to room temperature, add a lubricant, a nucleating agent and an antioxidant and stir for 5-30 min; and
S4: extrude the mixture of the S3 through a twin-screw extruder at a temperature of 200-300° C., where the long glass fiber is fed through a glass fiber opening, and then perform screening and dehydration through processes of drawing and pelletizing, to obtain flame-retardant nylon granules.

### Experimental Example 1: Specific Synthesis and Properties Testing of Chemically End-Capped Melamine Pyrophosphate

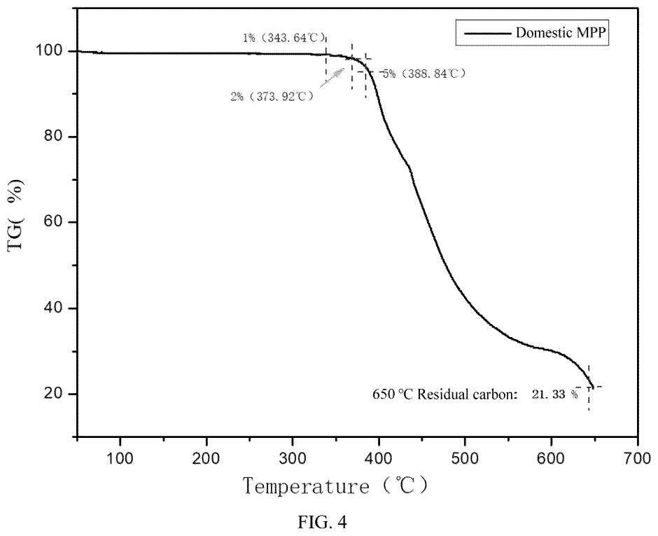

In this experimental example, a specific substance synthesis is performed based on a synthesis route of Example 1, and raw materials and parameters selected are shown in Table 1. Moreover, in a synthesis process of the melamine pyrophosphate and the chemically end-capped melamine pyrophosphate, a special device of this solution is used, and a material stirring screw rotates counterclockwise at a speed of about 200 rpm, and a cylinder of a rotary furnace rotates clockwise at a speed of about 50 rpm. Properties of the chemically end-capped melamine pyrophosphate obtained by synthesis are tested, including a 1% thermal weight loss temperature and whiteness. The 1% thermal weight loss temperature is measured according to a standard ASTM E2550-2007, and the whiteness is measured according to a standard GB/T 5950, with test results detailed in Table 2. Domestic melamine pyrophosphate is purchased from the market, and a TG chart is shown in FIG. 4.

TABLE 1
Synthesis conditions of the chemically end-capped melamine pyrophosphate

| Items | | Test 1 | Test 2 | Test 3 | Test 4 |
|---|---|---|---|---|---|
| Melamine | Reaction | Nitrogen | Nitrogen | Nitrogen | Nitrogen |
| pyrophosphate | environment | | | | |
| | Reaction | 320 | 340 | 340 | 340 |
| | temperature | | | | |
| | (° C.) | | | | |
| | Reaction | 0.05 | 0.15 | 0.2 | 0.1 |
| | pressure (MPa) | | | | |
| | Reaction time | 240 | 180 | 180 | 180 |
| | (min) | | | | |
| Synthesis of | Types of end- | Melamine | Urea | Biguanide | Iminodiacetonitrile |
| the chemically | capping | | | | |
| end-capped | reagents | | | | |
| melamine | A mass ratio of | 10:10000 | 20:10000 | 30:10000 | 30:10000 |
| pyrophosphate | the end-capping | | | | |
| | reagent to the | | | | |
| | melamine | | | | |
| | pyrophosphate | | | | |
| | Reaction | Nitrogen | Nitrogen | Nitrogen | Nitrogen |
| | environment | | | | |
| | Reaction | 300 | 280 | 240 | 240 |
| | temperature | | | | |
| | (° C.) | | | | |
| | Reaction | 0.2 | 0.5 | 0.4 | 0.4 |
| | pressure (MPa) | | | | |
| | Reaction time | 60 | 30 | 30 | 30 |
| | (min) | | | | |

TABLE 2
Properties test results

| | Domestic | | | | |
|---|---|---|---|---|---|
| Sample | MPP | Test 1 | Test 2 | Test 3 | Test 4 |
| Nitrogen | 41.2 | 42.6 | 42.1 | 42.4 | 42.2 |
| content/% | | | | | |
| Whiteness/% | 95.2 | 98.4 | 98.3 | 98.2 | 98.4 |
| 1% thermal | 343.64 | 372.12 | 373.53 | 376.84 | 376.55 |
| weight loss/° C. | | | | | |

It can be seen from the above experimental results that the chemically end-capped melamine pyrophosphate obtained by the synthesis method of this solution, compared with conventional melamine pyrophosphate in the prior art, has a more ideal whiteness (greater than 98%) and 1% thermal weight loss temperature (greater than 370° C.).

### Experimental Example 2: Specific Synthesis and Properties Testing of Flame-Retardant Nylon

In this experimental example, a specific substance synthesis is performed based on a synthesis route of Example 2, and raw materials and parameters selected are shown below:

Test 1:47.9 parts of nylon; 30 parts of long glass fiber; 10 parts of chemically end-capped melamine pyrophosphate (prepared in the Test 1 of Experimental Example 1); 10 parts of organic aluminum hypophosphite; 0.5 part of a flame-retardant synergist; 0.3 part of a nucleating agent; 0.5 part of a coupling agent; 0.5 part of a lubricant; and 0.3 part of an antioxidant 1098.

Test 2:47.9 parts of nylon; 30 parts of long glass fiber; 10 parts of chemically end-capped melamine pyrophosphate (prepared in the Test 2 of Experimental Example 1); 10 parts of organic aluminum hypophosphite; 0.5 part of a flame-retardant synergist; 0.3 part of a nucleating agent; 0.5 part of a coupling agent; 0.5 part of a lubricant; and 0.3 part of an antioxidant 1098.

Test 3:47.9 parts of nylon; 30 parts of long glass fiber; 10 parts of chemically end-capped melamine pyrophosphate (prepared in the Test 3 of Experimental Example 1); 10 parts of organic aluminum hypophosphite; 0.5 part of a flame-retardant synergist; 0.3 part of a nucleating agent; 0.5 part of a coupling agent; 0.5 part of a lubricant; and 0.3 part of an antioxidant 1098.

Test 4:47.9 parts of nylon; 30 parts of long glass fiber; 10 parts of chemically end-capped melamine pyrophosphate (prepared in the Test 4 of Experimental Example 1); 10 parts of organic aluminum hypophosphite; 0.5 part of a flame-retardant synergist; 0.3 part of a nucleating agent; 0.5 part of a coupling agent; 0.5 part of a lubricant; and 0.3 part of an antioxidant 1098.

Comparative Test 1:47.9 parts of nylon; 30 parts of long glass fiber; 10 parts of domestic melamine pyrophosphate; 10 parts of organic aluminum hypophosphite; 0.5 part of a flame-retardant synergist; 0.3 part of a nucleating agent; 0.5 part of a coupling agent; 0.5 part of a lubricant; and 0.3 part of an antioxidant 1098.

The nylon is PA66-EPR27; a diameter of the long glass fiber is 8 μm; the organic aluminum hypophosphite is aluminum diethylphosphinate; the flame-retardant synergist is anhydrous zinc borate; the nucleating agent is BRUGGOLEN P22; the coupling agent is KH-9130; and the lubricant is silicone powder.

Comparative Test 2: the difference from Test 1 lies in that organic aluminum hypophosphite is not added, and 20 parts of chemically end-capped melamine pyrophosphate (prepared in the Test 1 of Experimental Example 1) are added.

Comparative Test 3: the difference from Test 1 lies in that a flame-retardant synergist is not added, and 10.5 parts of chemically end-capped melamine pyrophosphate (prepared in the Test 1 of Experimental Example 1) are added.

Comparative Test 4: the difference from Test 1 lies in that a flame-retardant synergist is replaced with an equivalent amount of zinc oxide.

Comparative Test 5: the difference from Test 1 lies in that a flame-retardant synergist is replaced with an equivalent amount of zirconium phosphate.

In the Tests 1-4 and the Comparative Tests 1-5, a composite material is prepared according to the following method, which is a conventional method in the prior art: add nylon, chemically end-capped melamine pyrophosphate (or domestic melamine pyrophosphate), organic aluminum hypophosphite and a flame-retardant synergist into a mixer, stir at room temperature for 10 min, increase a temperature of the mixer to 150° C., ensure that a temperature of material in the mixer reaches a set temperature, and then add a coupling agent and continue stirring for 15 min; after cooling to room temperature, add a lubricant, a nucleating agent and an antioxidant and stir for 10 min; and extrude a final mixture through a conventional twin-screw extrusion process and a conventional twin-screw extruder of the prior art at a temperature of 220-260° C., where long glass fiber is fed through a glass fiber opening, and then perform screening and dehydration through processes of drawing and pelletizing, to obtain a composite material of flame-retardant reinforced nylon.

Comparative Test 6: the difference from the Test 1 lies in a preparation process, with details as follows: add nylon, chemically end-capped melamine pyrophosphate, organic aluminum hypophosphite, a flame-retardant synergist, a lubricant, a nucleating agent and an antioxidant into a mixer, stir at room temperature for 20 min, then increase a temperature of the mixer to 150° C., ensure that a temperature of material in the mixer reaches a set temperature, and then add a coupling agent and continue stirring for 15 min. A mixture obtained is used for subsequent twin-screw extrusion operations.

Comparative Test 7: the difference from the Test 1 lies in a preparation process, with details as follows: add nylon, chemically end-capped melamine pyrophosphate, organic aluminum hypophosphite, and a flame-retardant synergist into a mixer, stir at room temperature for 10 min, then increase a temperature of the mixer to 200° C., ensure that a temperature of material in the mixer reaches a set temperature, and then add a coupling agent and continue stirring for 15 min; and after cooling to room temperature, add a lubricant, a nucleating agent and an antioxidant and stir for 10 min; A mixture obtained is used for subsequent twin-screw extrusion operations.

Comparative Test 8: the difference from the Test 1 lies in a preparation process, with details as follows: add nylon and chemically end-capped melamine pyrophosphate into a mixer, stir at room temperature for 10 min, then increase a temperature of the mixer to 150° C., ensure that a temperature of material in the mixer reaches a set temperature, and then add a coupling agent and continue stirring for 15 min; and after cooling to room temperature, add a lubricant, a nucleating agent, an antioxidant, organic aluminum hypophosphite and a flame-retardant synergist and stir for 10 min. A mixture obtained is used for subsequent twin-screw extrusion operations.

A composite material of the flame-retardant reinforced nylon obtained by synthesis is subjected to properties tests, including a flame retardancy test, a “double 85” test, and an immersion test. The flame retardancy test is conducted based on the Test for Flammability of Plastic Materials for Parts in Devices and Appliances-UL 94; the “double 85” test for 1000 h is conducted based on Part 2 of GB/T 2423.50, with a test method being Test Cy: steady-state damp heat is mainly used for accelerated testing of components; and the immersion test is conducted based on the Polymeric Materials-Use in Electrical Equipment Evaluations-UL 746C, with test results detailed in Table 3.

TABLE 3
Flame-retardant nylon properties test results (NR means non-flame-retardant; “—”
means that this test is not required because of being non-flame-retardant at 0.8 mm)

| | Flame retardancy | | | | | | | |
|---|---|---|---|---|---|---|---|---|
| | | | | Total | | | | |
| | | | | residual | | | | |
| | | | | flame time | | | | Notched |
| | | | | for five | | | | impact |
| | UL 94 | | | 0.8 mm | “Double 85” | UL 746C | Tensile | strength/ |
| No. | 3.2 mm | 1.6 mm | 0.8 mm | samples | test for 1000 h | immersion test | strength/MPa | kJ/m² |
| Comparative | V-0 | V-0 | V-0 | 38.1 | Precipitation | Precipitation | 114.9 | 7.4 |
| test 1 | | | | | on a spline surface | on a spline surface | | |
| Comparative | NR | NR | NR | — | No precipitation | No precipitation | 119.7 | 8.0 |
| test 2 | | | | | on a spline surface | on a spline surface | | |
| Comparative | V-0 | NR | NR | — | No precipitation | No precipitation | 123.8 | 8.2 |
| test 3 | | | | | on a spline surface | on a spline surface | | |
| Comparative | V-0 | V-0 | NR | — | No precipitation | No precipitation | 121.4 | 8.0 |
| test 4 | | | | | on a spline surface | on a spline surface | | |
| Comparative | V-0 | V-0 | V-0 | 44.1 | No precipitation | No precipitation | 110.2 | 6.9 |
| test 5 | | | | | on a spline surface | on a spline surface | | |
| Comparative | V-0 | V-0 | V-0 | 34.6 | Precipitation | Precipitation | 111.4 | 7.2 |
| test 6 | | | | | on a spline surface | on a spline surface | | |
| Comparative | V-0 | V-0 | V-0 | 33.2 | Precipitation | No precipitation | 115.2 | 7.4 |
| test 7 | | | | | on a spline surface | on a spline surface | | |
| Comparative | V-0 | V-0 | V-0 | 28.8 | Precipitation | Precipitation | 110.9 | 7.1 |
| test 8 | | | | | on a spline surface | on a spline surface | | |
| Test 1 | V-0 | V-0 | V-0 | 21.6 | No precipitation | No precipitation | 123.7 | 8.3 |
| | | | | | on a spline surface | on a spline surface | | |
| Test 2 | V-0 | V-0 | V-0 | 23.3 | No precipitation | No precipitation | 127.5 | 8.8 |
| | | | | | on a spline surface | on a spline surface | | |
| Test 3 | V-0 | V-0 | V-0 | 23.4 | No precipitation | No precipitation | 126.2 | 8.7 |
| | | | | | on a spline surface | on a spline surface | | |
| Test 4 | V-0 | V-0 | V-0 | 24.8 | No precipitation | No precipitation | 124.3 | 8.7 |
| | | | | | on a spline surface | on a spline surface | | |

It can be seen from the above data that the composite material of flame-retardant reinforced nylon prepared by using the chemically end-capped melamine pyrophosphate of this solution as a flame-retardant (the Tests 1-4) exhibits more ideal flame retardancy and precipitation resistance. The flame-retardant nylon obtained in the Comparative Test 1 by using a commercially available melamine pyrophosphate flame retardant has certain flame retardancy, but has a poorer flame-retardant effect than those obtained in the Tests 1-4. Moreover, due to absence of chemical end-capping, mechanical properties and precipitation resistance of the nylon material obtained in the Comparative Test 1 are negatively affected to a certain extent.

Organic aluminum hypophosphite is not used in the Comparative Test 2, and a flame-retardant synergist is not used in the Comparative Test 3, thereby causing a very significant decline in the flame-retardant effect of nylon. This indicates that chemically end-capped melamine pyrophosphate, as a flame-retardant, needs to be used together with organic aluminum hypophosphite and a flame-retardant synergist in the process of preparing flame-retardant nylon to ensure that the flame-retardant effect is fully exerted. Absence of organic aluminum hypophosphite has a slight negative impact on the mechanical properties of flame-retardant nylon. Absence of either organic aluminum hypophosphite or a flame-retardant synergist has no impact on surface precipitation of flame-retardant nylon.

In the Comparative Test 4 and the Comparative Test 5, effects of different flame-retardant synergists are studied. A nylon material obtained when zinc oxide is used as a flame-retardant synergist, is inferior to that obtained when anhydrous zinc borate is used in terms of flame retardancy, without significant impact in other aspects. A nylon material obtained when zirconium phosphate is used as a flame-retardant synergist, is somewhat inferior to that obtained when anhydrous zinc borate is used in terms of flame retardancy, and the mechanical properties of the nylon material are also significantly negatively impacted.

The chemically end-capped melamine pyrophosphate prepared in this solution is added to a nylon material for the first time, and the inventor also explores the preparation process thereof. When nylon, chemically end-capped melamine pyrophosphate, organic aluminum hypophosphite, a flame-retardant synergist, a lubricant, a nucleating agent and an antioxidant are mixed at one time, and then a coupling agent is added, a prepared mixture is granulated by using a conventional twin-screw extruder (the Comparative Test 6). Although this method can reduce process complexity, adequate surface treatment of a raw material cannot be achieved by using a coupling agent (especially for the flame retardant of this solution), which affects dispersion of the material and further affects the flame retardancy and mechanical properties of product, such that precipitation resistance of the product is also deteriorated. A temperature of a mixture of nylon, chemically end-capped melamine pyrophosphate, organic aluminum hypophosphite and a flame-retardant synergist is increased to 200° C. (the Comparative Test 7). A high temperature is unfavorable for a coupling agent and the like added subsequently to exert their role, and even some flame-retardant components are slightly decomposed (less than 0.5%), which affects the flame-retardant effect and mechanical properties, such that precipitation resistance of the product is also deteriorated.

Nylon and chemically end-capped melamine pyrophosphate are mixed first, and then organic aluminum hypophosphite and a flame-retardant synergist are added (the Comparative Test 8), which affects the flame retardancy and mechanical properties of product, such that precipitation resistance of the product is also deteriorated. This further indicates the importance of adding organic aluminum hypophosphite and a flame-retardant synergist to chemically end-capped melamine pyrophosphate, and the three substances need to be mixed through a specific process to fully exert a synergistic effect between them.

### Comparative Example 1

This comparative example is essentially the same as the Test 1 of Experimental Example 1, and the difference lies in that in the two-step synthesis process, only the material stirring screw keeps rotating (consistent with the Test 1 of Experimental Example 1), but the cylinder of the rotary furnace (the reaction chamber) does not rotate, and other parameter conditions remain unchanged. The obtained chemically end-capped melamine pyrophosphate is tested in terms of the whiteness, the Nitrogen content and the 1% thermal weight loss temperature, and experimental results are shown in Table 4 (the Test 1 in Table 4 corresponds to the Test 1 in Table 2).

### Comparative Example 2

This comparative example is essentially the same as the Test 1 of Experimental Example 1, and the difference lies in that in the three-step synthesis process, a rotation speed of the material stirring screw is kept to be consistent with that of Test 1 of Experimental Example 1, but a rotation speed of the cylinder of the rotary furnace (the reaction chamber) is 150 rpm (faster rotation), and other parameter conditions remain unchanged. The obtained chemically end-capped melamine pyrophosphate is tested in terms of the whiteness, the Nitrogen content and the 1% thermal weight loss temperature, and experimental results are shown in Table 4.

### Comparative Example 3

This comparative example is essentially the same as the Test 1 of Experimental Example 1, and the difference lies in that in the three-step synthesis process, a rotation speed of the material stirring screw is maintained at 350 rpm (faster rotation), but a rotation speed of the cylinder of the rotary furnace (the reaction chamber) is consistent with that of the Test 1 of Experimental Example 1, and other parameter conditions remain unchanged. The obtained chemically end-capped melamine pyrophosphate is tested in terms of the whiteness, the Nitrogen content and the 1% thermal weight loss temperature, and experimental results are shown in Table 4.

TABLE 4
Properties test results of the chemically end-capped
melamine pyrophosphate in Comparative Examples 1-3

| | Comparative | Comparative | Comparative | |
|---|---|---|---|---|
| Sample | Example 1 | Example 2 | Example 3 | Test 1 |
| Nitrogen | 41.4 | 41.7 | 41.8 | 42.6 |
| content/% | | | | |
| Whiteness/% | 94.4 | 96.9 | 97.8 | 98.4 |
| 1% thermal | 352.1 | 362.8 | 367.6 | 372.12 |
| weight loss/° C. | | | | |

It can be seen from the above experimental data that in a synthesis process, the material stirring screw and the cylinder of the rotary furnace (the reaction chamber) rotate in different directions at a certain speed, which is very critical for enhancing the whiteness and the nitrogen content of the flame retardant and reducing the thermal weight loss. When only the material stirring screw rotates, even if its rotation speed is increased (Comparative Example 1→Comparative Example 3), the whiteness and the 1% thermal weight loss temperature of a product obtained are not ideal. When the rotation speed of the cylinder of the rotary furnace (the reaction chamber) is too fast (Comparative Example 2), improvement in the whiteness and 1% thermal weight loss temperature will also be affected.

What is described above is merely an example of the present disclosure, and common general knowledge such as well-known specific technical schemes and/or characteristics in the solution is not described too much herein. It should be noted that those skilled in the art may further make several transformations and improvements on the premise of not deviating from the technical scheme of the present disclosure, and these transformations and improvements should fall within the scope of protection of the present disclosure without affecting the implementation effect of the present disclosure and the practicability of the patent. The protection scope of the present disclosure shall be determined by the terms of the claims, and the specific embodiments and other records in the specification can be used to interpret the content of the claims.

What is claimed is:

1. A chemically end-capped melamine pyrophosphate flame retardant with high temperature resistance and precipitation resistance, wherein a structure of the melamine pyrophosphate is represented by a following chemical formula, and the melamine pyrophosphate is end-capped by an end-capping reagent; 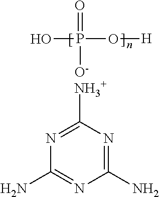
wherein n=1000-3000; and the end-capping reagent is a nitrogen-containing compound containing no hydroxyl group but an N—H bond.

2. The chemically end-capped melamine pyrophosphate flame retardant with high temperature resistance and precipitation resistance according to claim 1, wherein the end-capping reagent comprises at least one of R—NH₂, R═NH, melamine, urea, biguanide and iminodiacetonitrile; and R is an alkyl group with 1-4 carbon atoms.

3. A method for preparing a chemically end-capped melamine pyrophosphate flame retardant with high temperature resistance and precipitation resistance according to claim 1, comprising the following steps performed sequentially:
S1: dehydrating melamine phosphate by thermal polymerization to obtain melamine pyrophosphate;
S2: performing thermal treatment of the melamine pyrophosphate and the end-capping reagent, to obtain the chemically end-capped melamine pyrophosphate.

4. The method for preparing a chemically end-capped melamine pyrophosphate flame retardant with high temperature resistance and precipitation resistance according to claim 3, wherein reaction processes of S1 and S2 are both executed in an inert gas environment; a reaction temperature, pressure and time of S1 are 220-360° C., 0.05-0.3 MPa, and 60-300 min, respectively; and a reaction temperature, pressure and time of S2 are 180-360° C., 0.1-1.5 MPa, and 30-240 min, respectively.

5. The method for preparing a chemically end-capped melamine pyrophosphate flame retardant with high temperature resistance and precipitation resistance according to claim 3, wherein the reaction processes of S1 and S2 are both executed in a thermal polymerization reaction device; the thermal polymerization reaction device comprises a rotary furnace and a temperature control unit; a reaction chamber is arranged in the rotary furnace, and a material stirring screw is coaxially arranged in the reaction chamber; the temperature control unit is configured for controlling a temperature in the reaction chamber; and during the reaction process, the material stirring screw and the reaction chamber maintain different rotation directions.

6. The method for preparing a chemically end-capped melamine pyrophosphate flame retardant with high temperature resistance and precipitation resistance according to claim 3, wherein a rotation speed of the material stirring screw is 30-300 rpm, and a rotation speed of the reaction chamber is 3-120 rpm.

7. An application of the chemically end-capped melamine pyrophosphate flame retardant with high temperature resistance and precipitation resistance according to claim 2 in flame-retardant nylon.

8. The application of the chemically end-capped melamine pyrophosphate flame retardant with high temperature resistance and precipitation resistance in flame-retardant nylon according to claim 7, wherein the flame-retardant nylon comprises the following raw materials in parts by weight: 30-80 parts of nylon, 5-60 parts of long glass fiber, 5-20 parts of chemically end-capped melamine pyrophosphate, 5-20 parts of organic aluminum hypophosphite, 0.5-4 parts of a flame-retardant synergist, 0.3-2 parts of a nucleating agent, 0.5-2 parts of a coupling agent, 0.3-3 parts of a lubricant, and 0.2-1 part of an antioxidant.

9. The application of the chemically end-capped melamine pyrophosphate flame retardant with high temperature resistance and precipitation resistance in flame-retardant nylon according to claim 8, wherein the nylon comprises at least one of nylon 6, nylon 66, nylon 46, nylon 610, nylon 612, nylon 9, nylon 11, nylon 12, nylon 1010, nylon 1012, and nylon 1212; the long glass fiber is a rolled alkali-free glass fiber; the organic aluminum hypophosphite is aluminum diethylphosphinate; the flame-retardant synergist comprises at least one of anhydrous zinc borate, zinc borate 3.5 hydrate, zinc oxide, and zirconium phosphate; the nucleating agent is BRUGGOLEN P22; the coupling agent is a silane coupling agent; the lubricant comprises at least one of ethylene bis stearamide, pentaerythritol stearate, silicone powder and amide wax; and the antioxidant comprises at least one of an antioxidant 168, an antioxidant 1010 and an antioxidant 1098.

10. An application of the chemically end-capped melamine pyrophosphate flame retardant with high temperature resistance and precipitation resistance according to claim 9 in flame-retardant nylon, wherein the flame-retardant nylon is prepared by the following method:
S1: adding nylon, chemically end-capped melamine pyrophosphate, organic aluminum hypophosphite and a flame-retardant synergist into a mixer, and stirring at room temperature for 5-30 min;
S2: increasing a temperature of the mixer to 80-180° C., and adding a coupling agent and continuing to stir for 10-30 min;
S3: after cooling to room temperature, adding a lubricant, a nucleating agent and an antioxidant, and stirring for 5-30 min to obtain a premix; and
S4: extruding the premix through a twin-screw extruder at a temperature of 200-300° C., wherein the long glass fiber is fed through a glass fiber opening, and then performing screening and dehydration through processes of drawing and pelletizing, to obtain flame-retardant reinforced nylon granules.
